(19) United States
(12) Patent Application Publication
(10) Pub. No.: US 2004/0190046 A1
(43) Pub. Date: Sep. 30, 2004

(54) Service processor, service processing system and source data storing method for service processing system

(75) Inventor: Hiroshi Ilda, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/660,581

(22) Filed: Sep. 12, 2003

(30) Foreign Application Priority Data
Mar. 24, 2003 (JP) 2003-081199

(51) Int. Cl. G06F 15/00; H04N 1/00

(52) U.S. Cl. 358/1.15; 358/401

(57) ABSTRACT

There is provided a service processor which can easily take an adequate measure for an occurrence of a fault. Each service processor decides whether a setting of storing is described or not in individual instruction information. When the setting of storing is not performed, processing of the service processor is terminated here. When the setting of storing is performed, source data of a process object document is stored in relation to a service ID to identify a service requested from a cooperation process server. Moreover, each service processor decides whether current time is a predetermined timing (for example, predetermined time or time instructed by a user or the like) or not. When the current time is the predetermined timing, the source data stored in relation to the service ID is transferred to the cooperation process server.

### BACKGROUND OF THE INVENTION

The present invention relates to a service processor, a service processing system, a source data storing method for service processing system and a service processing program, particularly to a service processor, a service processing system, a source data storing method for service processing system and a service processing program which are suitable for the service processing system to form work flow by generating electronic data of paper documents.

It has been proposed to establish a work flow system which is intended to implement common use of paper documents and electronic information by mutually connecting a scanner, a facsimile device, a copying device, or a composite device including these devices, a personal computer, and a mail server or the like through a network.

With development of the Internet technology, it has also been proposed to provide a Web service which can easily establish more sophisticated job processes through cooperation of independently developed applications. The high-level job systems can easily be established by utilizing applications on the network as the service components with the Web services. Accordingly, new services can also be implemented through organic cooperation and combination of these services.

For example, the technology described in the cited Patent Reference 1 defines a work flow of the job process profile to perform the jobs having the flows in which plural persons in charge take a part while electronic mail, electronic documents and job data are mutally exchanged among the information processors by utilizing such information processors such as work stations (WS) and personal computers (PC) connected to the network such as LAN and WAN. Moreover, this technology also proposes a work flow management system, including a work flow server to issue individual job instructions based on such a definition and detect/monitor the progressing condition of individual jobs, a work flow client terminal to receive job instructions issued by the work flow server in order to execute such jobs, a batch process type job execution part in which the job application program is driven automatically by the client terminal, a part to notify the result of execution to the work flow server, and a work flow execution control part in which the work flow server decides the result of execution of the batch process type job based on the previously defined deciding condition and the flow of work flow is controlled depending on the result of the decision. With the work flow management system configured as described above, it is now possible to effectively introduce, during the work flow job, the batch process type word flow activity to automatically execute a job application program into an information processor.

[Patent Reference 1 ]

Japanese Published Unexamined Patent Application No. 2001-2829770

However, in the work flow system such as the technology described in the cited patent reference 1, it is considered to take a proper measure for occurrences of faults by storing source data to be inputted to individual services, but such a work flow system has a problem that when various services are provided, these services cannot be cooperated and it is therefore difficult to search the process how the source data to be processed has been converted and processed.

Moreover, in some cases, storing of the source data is restricted depending on the amount of data and capacity. But, there are some cases where data is not required, where it is not required to store the source data, or where the stored data should not be disclosed to other persons.

In addition, there rises also a problem that the amount of data increases up to the extraordinary amount when the source data is stored for every service.

### SUMMARY OF THE INVENTION

The present invention has been proposed considering the circumstances described above and provides, therefore, a service processor, a service processing system, a source data storing method for a service process system, and a service process program which can easily take an appropriate measure to occurrences of faults.

According to an aspect of the present invention, there is provided a service processor which processes, in cooperation, various services to execute processes of document data on a network, including a storage part which stores source data before a process in the own device in relation to identifying information to identify cooperation of services; and a control part which controls the storage based on setting information which presets whether the source data should be stored or not.

According to another aspect of the present invention, there is provided a service processing system which processes, in cooperation, various services to perform processes of document data on a network, including the service processor and a storage device which stores the source data stored in the storage part.

According to another aspect of the present invention, there is provided a source data storing method of a processing step of processing services to perform, in cooperation, processes of document data according to a process content among plural service processors connected to a network;

a storing step of storing source data before the process in the service processor in a predetermined storage area in relation to identifying information to identify cooperation of the service based on setting information which is preset to decide whether the source data included in the process content should be stored or not.

According to another aspect of the present invention, there is provided a service processor for processing services to a document data at several service domains on a network cooperatively comprising, a storage provided to a service domain, the storage stores a source data to be processed at the service domain with a data for defining the services; and a controller that controls whether the storage should store the source data or not in accordance with a preset data.

### BRIEF DESCRIPTION OF THE DRAWINGS

A preferred embodiment of the present invention will be described in detail based on the following figures, wherein:

FIG. 1 is a block diagram showing a structure of a document processing system of a preferred embodiment of the present invention;

FIG. 2 is a block diagram showing a schematic diagram of a service processor in the document processing system of the preferred embodiment of the present invention;

FIG. 3 is a block diagram for describing mutual relationship among service processors forming the document processing system of the preferred embodiment of the present invention;

FIG. 4 is a diagram showing a format of the I/F information;

FIG. 5 is a diagram showing an example of the instruction form creation image as the GUI image to define a job flow;

FIG. 6 is a diagram showing an example of the instruction form formed in the XML format;

FIG. 7 is a flowchart showing an example of processing procedures of a client terminal and an instruction form creation server at the time of creating the instruction form;

FIG. 8 is a diagram showing an example of the service cooperation process selection image showing an instruction form list;

FIG. 9 is a flowchart showing an example of the processes performed in each service processor;

FIG. 10 is a block diagram showing an example of storing of the source data; and

FIG. 11 is a block diagram for describing mutual relationship among service processors to form a document management system as a modification example.

### DESCRIPTION OF PREFERRED EMBODIMENT

A preferred embodiment of the present invention will be described in detail with reference to the accompanying drawings.

First, a basic structure of the document processing system of this embodiment of the present invention will be described

(Basic Structure of the System)

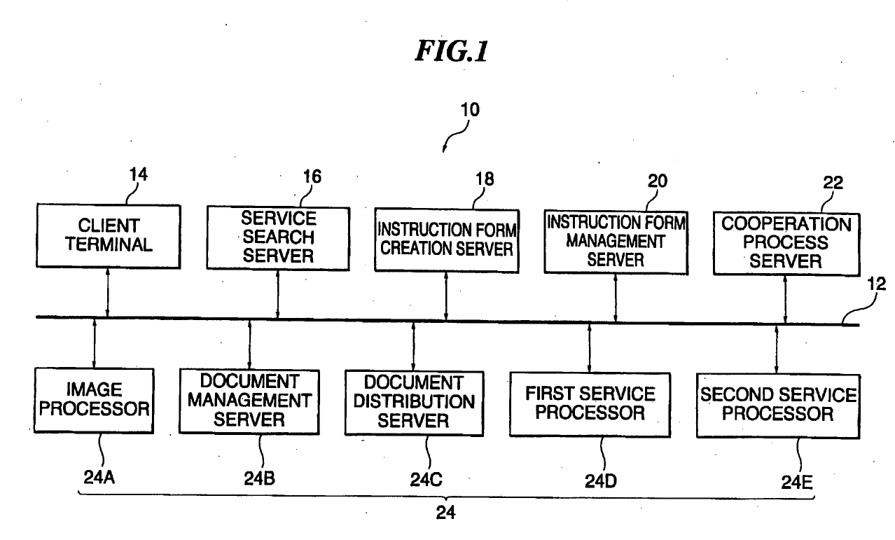

FIG. 1 is a block diagram showing a structure document processing system 10 of the embodiment of the present invention.

In a document management system 10, various services and applications are connected with each other via a network 12. Here, services are referred to as the functions to be used for documents depending on the requests issued from the external side. The services correspond, for example, to copying, printing, scanning, facsimile transmission and reception, mail distribution, storing and reading to/from a repository, OCR (Optical Character Recognition) process, and noise removing process or the like and are not restricted thereto.

The document management system 10 is practically provided with a client terminal 14 including an user interface for instructing the desired processes of users through cooperation of plural services, a service search server 16 for searching the desired services of users, an instruction form creation server 18 for creating an instruction form from the information about service cooperation instructed from the client terminal 14, an instruction form management server 20 for management of the instruction form, and a cooperated processing server 22 for executing cooperated processes of each service in accordance with the instruction form.

Moreover, the document processing system 10 is further provided, as service processors 24 to execute various services, with an image processor 24A for image processing such as noise removing process of image document, image rotating process, OCR process and binding of image or the like, a document management server 24B for management of documents, a document distribution server 24C for distribution of documents, a first service processor 24D for the first service process, and a second service processor 24E for the second service process.

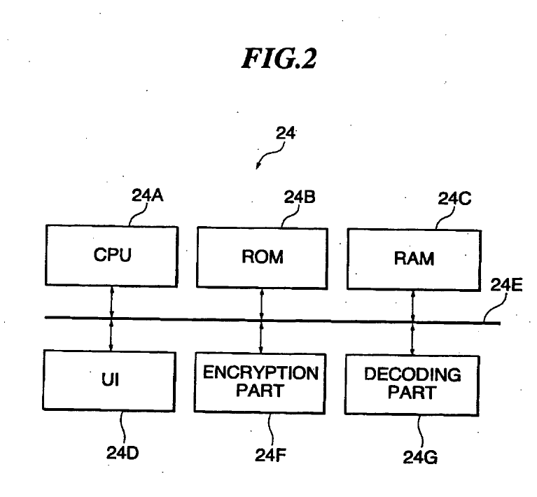

Each of the service processors 24 described above is also provided, as illustrated in FIG. 2, with a-CPU 24a, a ROM 24b, a RAM 24c, and a microcomputer in which a user interface (UI) 24d is connected to a bus 24e.

The ROM 24b stores applications and programs for execution of various services and a program or the like for execution of service cooperation.

Moreover, this embodiment is configured to conceal the information about the services to be performed with each of the service processors 24 through the connection of an encryption unit 24f and a decoding unit 24g to the bus 24e. Therefore, the data such as the source data and data after processes to be inputted to the service processor 24 can be encrypted with the encryption unit 24f and the encrypted data can be decoded with the decoding unit 24g.

Moreover, each of the service processors 24 in this embodiment is capable of storing, for the purpose such as recovery of data when a fault occurs, the source data inputted thereto or the source data storing location information and the information for identifying contents of process and documents as the processing object to the RAM 24c. In this case, a service ID for identifying contents of process and cooperation of the relevant service is also stored together with the source data Here, it is also possible to provide an exclusive memory in place of the RAM 24c and then store the source data or the like to this memory.

The document processing system 10 of this embodiment is configured to connect plural servers to perform the predetermined service processes via the network 12 but is not restricted to this structure so long as the plural services are connected via the network 12.

Here, the instruction form is referred to as the data including the information showing the relationship among functions when a series of processes are decomposed into plural functional processes, the interface (I/F) information to call each function, and the information to form a graphical user interface (GUI) in relation to a series of process.

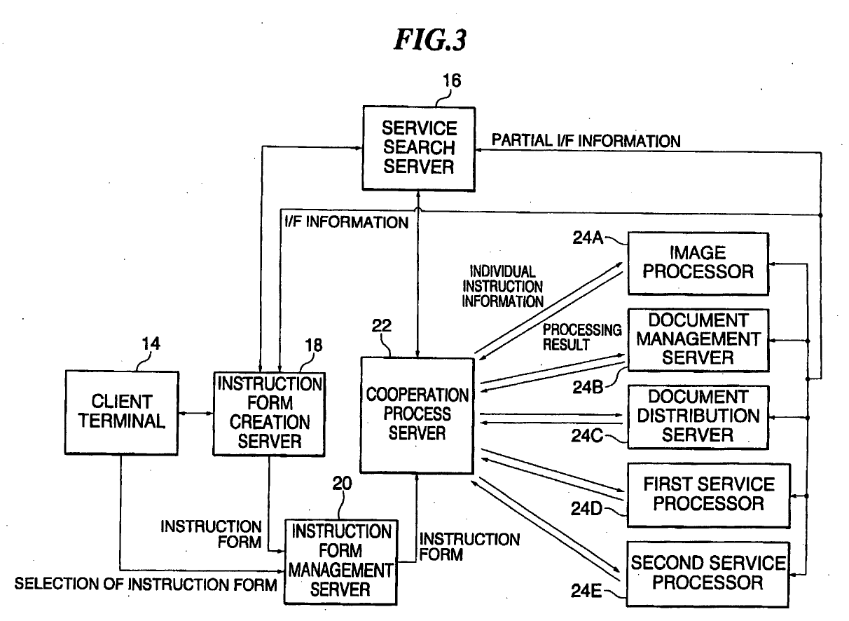

FIG. 3 is a block diagram showing mutual relationship among the service processors 24 to form the document processing system 10. The service processors 24 store the I/F information showing contents of services provided therefrom.

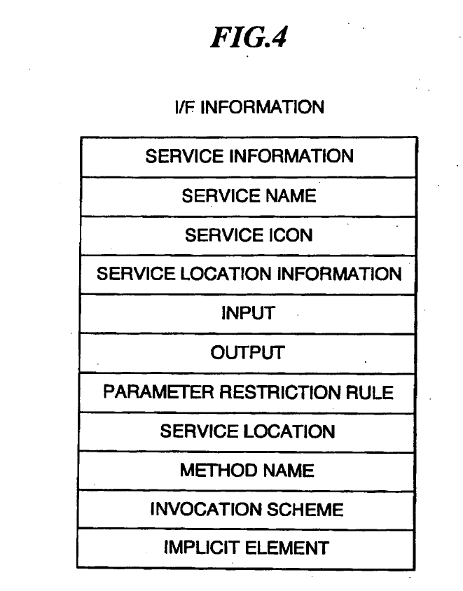

FIG. 4 is a diagram showing a format of the I/F information. The I/F information includes <service class>, <service name>, <service icon>, <service location information>, <input>, <output>, <parameter restriction rule>, <service location>, <method name>, <invocation scheme>, and <implicit element>.

The <service class> indicates a class of service provided by the service processors 24. As the <service class>, the predetermined class of service is used and it corresponds, for example, to scanning, printing, repository, and flow or the like. The <service name> indicates a name of service provided by the service processors 24. The <service icon> indicates the location information of icon to be displayed in the GUI of the client terminal 10.

The <service location information> indicates the URL used by the instruction form creation server 30 to obtain the I/F information. The <input> indicates an input to the service. The <Output> indicates an output from the service. The <parameter restriction rule> indicates the restriction rule to be applied to the <input> and <output>. The <service location> indicates the location information when the service is actually used. The <method name> indicates the name to suggest the method to provide the service process and the service.

The <invocation scheme> indicates a method of calling and invocation of service process. As the <invocation scheme>, the SOAP (Simple Object Access Protocol) and STMP (Simple Mail Transfer Protocol) or the like, for example, which are protocols for message exchange, may be used. The <implicit element> indicates the data which may be referred in the processes of the subsequent stages, although this data is never transferred implicitly as the output to the processes of the subsequent stage.

The client terminal 14 has the function of the graphical user interface (GUI) for display of an image and the predetermined operations in order to instruct creation of instruction form and select the instruction form to be driven and the function of the user interface (UI) for an analysis of a fault when a fault is generated during provision of the services.

The service search server 16 searches the services corresponding to the search condition from the plural services connected to the network 12. The service search server 16 previously stores a part of the TI information pieces (hereinafter referred to as partial I/F information) of the service processors 24 such as the image processor 24A, document management server 24B, document distribution server 24C, first service processor 24D and service processor 24E. Here, this partial I/F information includes the <service class>, <service name>, <service location information>, <input> information and <output> information in the I/F information element.

The service search server 16 searches the services using the partial I/F information of each of the service processors 24 when the search conditions are transmitted from the instruction form creation server 18 and cooperation process server 22. For example, when the service similar to the predetermined service is searched, it is enough for the service search server 16 to search the services in which the <service class> is matched, or to search the services in which the <input> and <output> are matched or to search the services in which these elements are all matched.

The instruction form creation server 18 obtains the I/F information from each of the service processors 24 at the time of creating the instruction form and also creates the instruction form for cooperation of services provided by each of the service processors 24. The instruction form creation server 18 executes, in practice, the following processes in view of creating the instruction form.

The instruction form creation server 18 requests the transmission of the I/F information about each service from the predetermined service processor 24 scattered on the network 12 based on the <service location information>. The instruction form creation server 18 issues, when the predetermined service processor 24 is not provided, an instruction to the service search server 16 to search another service processor 24 to provide the same service as that of the predetermined service processor 24. Thereby, the instruction form creation server 18 can obtain the <service location information> of the other service processor 24 from the service search server 16.

The instruction form creation server 18 performs the management for the search result from the service search server 16 and the I/F information received from each of the service processors 24. The instruction form creation server 18 creates an HTML file which will become the GUI image to define the job flow based on the I/F information obtained from each of the service processors 24. Moreover, the instruction form creation server 18 transmits, upon issuance of request to read the service from the client terminal 14, the HTML file which will becomes the GUI image to the client terminal 14.

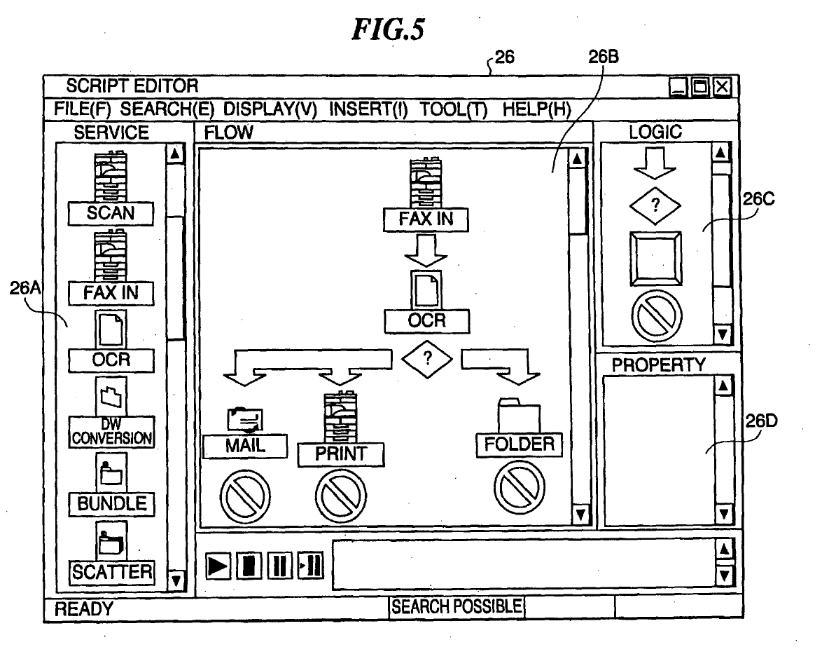

FIG. 5 is a diagram showing an instruction form creation image 30 as the GUI image to define a job flow. The instruction form creation image 26 is formed of a service window 26A, a flow window 26B, a logic window 26C, and a property window 26D.

The service window 26A displays various available service processors 24. The logic window 26C displays a job flow to show the cooperated patterns among services. The property window 26D displays the detail setting parameters of icons displayed in the service window 26A and logic window 26C.

A user can define the job flow in the flow window 26B through the drag-and-drop of the icon of the service window 26A and the icon of the logic window 26C to the flow window 26B. Moreover, a user can set in detail the relationship among the services and the services of logic by editing the contents displayed in the property window 26D.

The client terminal 14 transmits the job flow information defined with operations by users to the instruction form creation server 18.

The instruction creation server 18 creates, based on the job flow information in regard to the instruction of service cooperation from users and the I/F information of each service, the instruction form defining the information to identify the document as the processing object such as contents of process requested to each service, input parameter, a way of cooperation of service (job flow), document name and storing location information or the like. The instruction form is formed, in this embodiment, of a file in the XML format

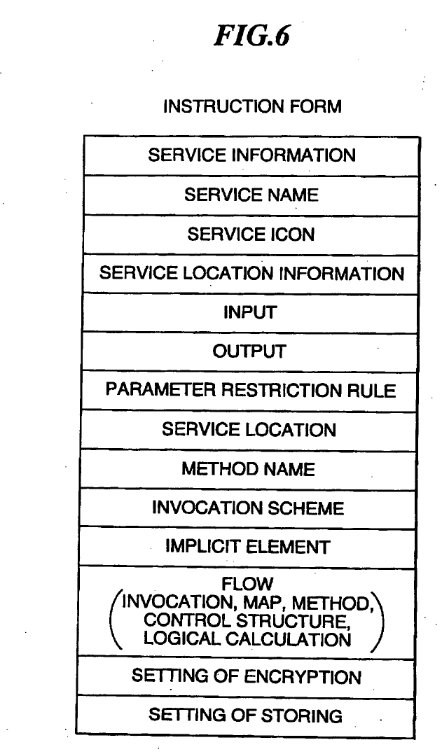

FIG. 6 is a diagram showing the instruction form formed in the XML format. Since the cooperated process itself of plural services is considered as only one service, the instruction form is formed in the format where the <flow>, <setting encryption> and <setting of storing> are added to the I/F information illustrated in FIG. 4.

The element <flow> is described to indicate cooperation of services including the element of <invocation> and <if> or the like for control structure and logical calculation, and decisions for conditions, instruction for operation of the XML structure for adjustment of cooperation among services and moreover the information to identify the document of the processing object.

The element <invocation> indicates a particular method of the service processors 24 and executes the calling of service. As the element of <invocation>, <map> indicating the location information of parameter and <method> indicating the name of method to be called are provided. The elements <if>, <and>, <eq>, <gt) indicating the control structure and logical calculation or the like are used to perform the branching of condition in the cooperated processes and adjustment of parameters transferred among the services.

The element <setting of encryption> indicates whether the document as the process object should be encrypted or not and the encryption may be set when the instruction form is created. Moreover, the element <setting of storing> indicates whether or not the source data to be inputted to each of the service processors 24 should be stored in each of the service processors 24 and this element may also be set when the instruction form is created.

The instruction form describes all information pieces regarding control of cooperation process of services in the element <flow>. Accordingly, the cooperation process itself indicated by the instruction form is considered as a service. Here, the instruction form is never restricted to the format illustrated in FIG. 6 and it is enough when the instruction form can be cooperated with each service.

The instruction form creation server 18 transmits the instruction form of the XML format described above to the instruction form management server 20. Moreover, the instruction form creation server 18 can also transmit the instruction form directly to an cooperation process server 22 when execution of service cooperation process is instructed from users.

The instruction form management server 20 stores the instruction form transmitted from the instruction form creation server 18 and transmits the instruction form to the cooperation process server 22 depending on the request from the client terminal 14.

The cooperation process server 22 is provided to interpret and execute the designated instruction form and manage simultaneously the source data before the service and contents of process or the like stored in each of the service processors 24 to take a measure when a fault is generated. When the instruction form is transmitted, the cooperation process server 22 interprets this instruction form, sequentially calls the service processors 24 such as image processor 24A, document management server 24B, and document distribution server 24C in accordance with the sequence and application method described in the instruction form, and executes the cooperated processes. In addition, the cooperation process server 22 stores the information for indicating conditions of cooperated processes being executed and a result of the cooperated processes completed and then notifies the condition and result of cooperated processes depending on the external requests. Moreover, the cooperation process server 22 stores, for recovery from a fault when the fault is generated during execution of service based on the instruction form, the source data before the service process or the like stored in each of the service processors 24 depending on the <setting of storing> described in the instruction form in the predetermined timing (for example, preset time or instruction by user when the amount of data has reached the predetermined amount) and thereby can take a proper measure for the fault using the source data or the like stored when the fault has occurred.

The cooperation process server 22 creates, to interpret the instruction form and then sends a request to each of the service processors 24, the individual instruction information including the process request contents, input parameters, information for identifying the document as the process object and the service ID for identifying the job flow (service cooperation) based on the instruction form, or the like. The cooperation process server 50 is capable of extracting the information related to the service processes before and after the cooperated process among those executed in each of the service processors 24 and then describing this information to the instruction form or is also capable of sending a request in the exclusive information exchange format for each of the service processors 24 in place of the format of the instruction form.

The image processor 24A is a computer to which a software program is installed to perform the image processing function. The image processor 24A processes the documents based on the service process request contents, input parameter, and information of document as the process object included in the process request message. Moreover, the image processor 24A notifies the partial I/F information to the service search server 16 at the time of invocation. In addition, the image processor 24A transmits, responding to the request from the instruction form creation server 18, the I/F information indicating the application method of the image processing service. This I/F information is used when the instruction form is created.

The document management server 24B has the document storing function. The document management server 24B executes storing, search and read of documents, change of attributes and various processes for the documents based on the information included in the request from the cooperation process server 22. Moreover, the document management server 24B also notifies, to the service search server 16, the partial I/F information at the time of invocation. In addition, the document management server 24B transmits the I/F information indicating the application method of the document management service responding to the request from the instruction form creation server 18.

The document distribution server 24C is provided with the functions to store the obtained documents to the document management server instructed, transmit the data in the form of mail and facsimile to the instructed destination address and perform the output process to the instructed printer. The document distribution server 24C performs document distribution process based on the document instructed in the client terminal 14 and information of distribution address, responding to the request from the cooperation process server 22. Moreover, the document distribution server 24C notifies the partial I/F information to the service search server 16 at the time of invocation. In addition, the document distribution server 24C transmits the I/F information indicating the application method of the distribution process service responding to the request from the instruction form creation server 18.

The first service processor 24D executes the predetermined service processes in regard to the documents in accordance with the instructions from the external side. Here, the first service processor 24D executes the service processes to be executed thereby based on the information such as process request contents, input parameter and information to identify the documents as the process object from the cooperation process server 22. Moreover, the first service processor 24D notifies, when it is invoked, the partial VIP information to the service search server 16. Moreover, the first service processor 24D transmits the I/F information indicating the application method of the service process responding to the request from the instruction form creation server 30. Here, the second service processor 24E operates in the same manner as the first service processor 24D, except for the contents of a service process.

Further, each of the service processors 24 described above performs encryption depending on the setting of encryption defined in the instruction form and also stores the service ID or the like to identify the process contents and job flow of the instruction form in relation to the source data before a service process depending on the setting of storing. In addition, each of the service processors 24 transfers, at a predetermined timing (for example, preset time or instruction from user when the amount of data has reached the predetermined amount), the contents stored in each of the service processors 24 to the cooperation process server 22.

In the document process system 10 configured as described above, each of the service processors 24 such as the image processor 24A, document management server 24B, document distribution server 24C, etc. operates as follows when the application program to execute the predetermined services is installed.

Each of the service processors 24 such as the image processor 24A, document management server 24B, document distribution server 24C, first service processor 24D, and second service processor 24E, etc. notifies, in its invocation processes, the partial I/F information including the information indicating the outline of service and address thereof to the service search server 16.

Meanwhile, the service search server 16 stores the partial I/F information transmitted-from each of the service processors 24 such as the image processor 24A, document management server 24B, document distribution server 24C, first service processor 24D, and second service processor 24E, etc. Accordingly, the service search server 16 executes the search using the partial I/F information when the predetermined service search request is issued, for example, from the instruction form creation server 18 and cooperation process server 22.

(Creation of Instruction Form)

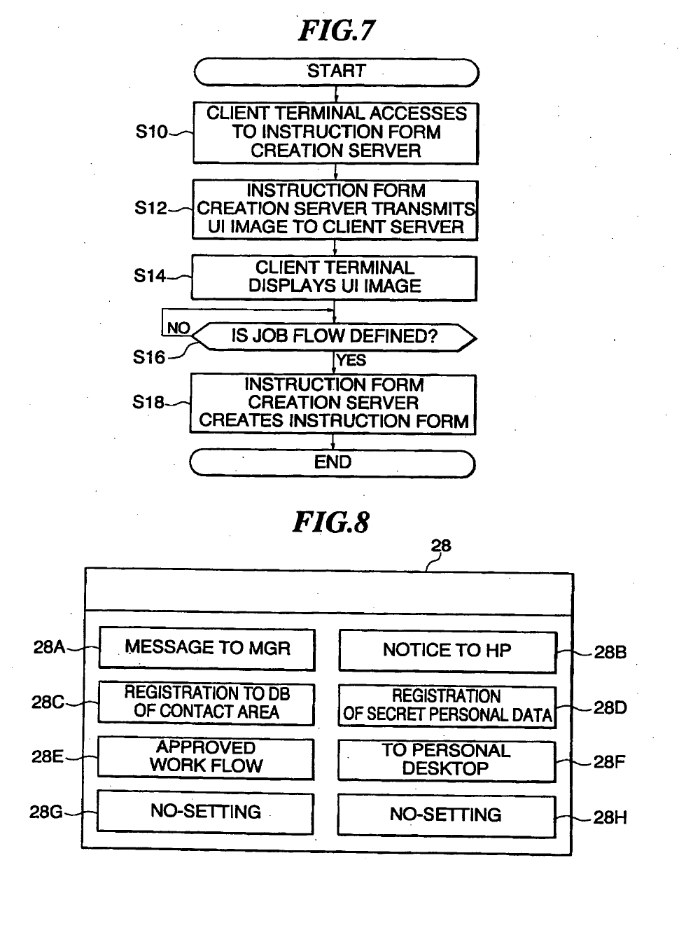

FIG. 7 is a flowchart showing the process procedures of the client terminal 14 and instruction form creation server 18 when the instruction form is created.

The client terminal 14 makes access to the URL (Uniform Resource Locator) of the HTML file created for the user interface image provided with the instruction form creation server 18 through the installed browser in accordance with the user operations (step S10).

The instruction form creation server 18 transmits the HTML file in the user interface image to the client terminal 14 responding to the read request from the client terminal 14 (step S12).

The client terminal 14 displays the user interface image based on the information forming the image, for example, included in the HTML file transmitted from the instruction form creation server 18 (step S14). At this time, a user can define the job flow of the desired service cooperation using the user interface image displayed on the client terminal 14. In this case, in each service, setting for validation and invalidation of encryption of document or setting for storing or non-storing of the source data before the service process in each of the service processors 24 can also be defined simultaneously.

The client terminal 14 also decides whether the job flow has been defined or not via the user interface image and enters the waiting condition until the job flow is defined (step S16). When the job flow is decided to have been created, the client terminal 14 transmits the job flow information of service cooperation defined by a user to the instruction form creation server 18.

The instruction form creation server 18 creates the instruction form, based on the information about job flow of the service cooperation transmitted from the client terminal 14 and the I/F information obtained from each of the service processors 24, having defined the contents of process requested to each service, input parameter, a way of cooperation of each service, document name, storing location information and information to identify the document as the process object (service ID) or the like (step S18). Here, the instruction form creation server 18 transmits the instruction form of the XML format to the instruction form management server 20.

The instruction form management server 20 stores the instruction form created in the instruction form creation server 18. The instruction form management server 20 is already storing the plural instruction forms created in the instruction form creation server 18 and therefore reads, when selection of instruction form is instructed from the client terminal 14, the instruction form instructed.

(Invocation Execution of Cooperated Processes)

A user can select the desired instruction form from the plural instruction forms stored in the instruction form management server 20 to invoke, specifically the cooperated processes as follows.

The client terminal 14 obtains the instruction form list under the management of the instruction form management server 20 by making access to the instruction form management server 20. For example, the client terminal 14 obtains the service cooperation process selection image 28 indicating the instruction form list as illustrated in FIG. 8 and selects the desired instruction form. The instruction form can be selected with a user, for example, by selecting a button corresponding to the desired instruction form from the buttons 28A to 28H provided to select the instruction form for every instruction form of the service cooperation process selection image 28.

The client terminal 14 selects the instruction form indicating the predetermined service cooperation process from the service cooperation process selection image 28 based on the user's operation instruction and instructs invocation of the selected instruction form. In this case, the parameter input image is displayed for the user to receive the input of parameters required for execution of job.

The instruction form management server 20 transmits the instruction form instructed by the client terminal 14 to the cooperation process server 22. As a result, the cooperation process server 22 starts execution of the cooperated process.

Namely, the cooperation process server 22 interprets the instruction form transmitted from the instruction form management server 20 and requests execution of the service process to the service processors 24 described in the instruction form. Specifically, the cooperation process server 22 extracts, based on the information described in the instruction form, the locations of the service processors 24 which request the process, format of input and output parameters required for process request, method name for process request, invocation method, information to identify the document as the process object, setting of encryption and setting of storing or the like and then creates individual instruction information and a service ID. The cooperation process server 50 transmits the individual instruction information and service ID to each of the service processors 24 described in the instruction form. Moreover, the cooperation process server 22 requests execution of the service process to each of the service processors 24 in the sequence determined in the instruction form

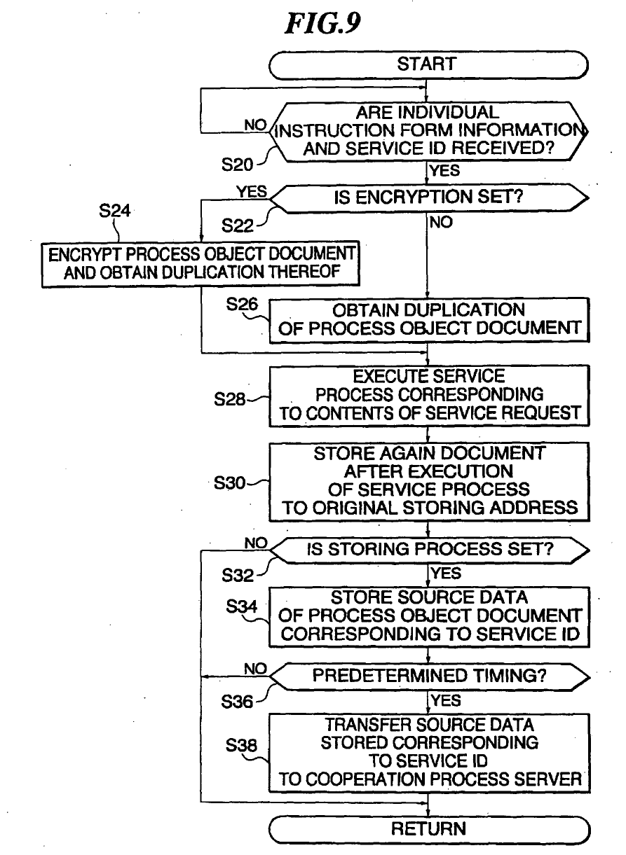

Here, an example of the processes to be executed by each of the service processors 24 will be described with reference to the flowchart of FIG. 9.

Each of the service processors 24 decides first whether or not the individual instruction information and service ID have been received from the cooperation process server 22 and enters the waiting condition until these are received (S20). Each of the service processors 24 decides, upon reception of the individual instruction information and service ID, whether encryption is set or not in the individual instruction information (S22). When the encryption is set, the document as the process object is encrypted and its duplication is obtained based on the storing location information of the process object document described in the individual instruction information (S24). When setting of encryption is made, in this case, the source data of the storing destination is also encrypted for the restoring. Moreover, when the encryption is not yet set, the document can be obtained by duplicating the process object document based on the storing location information of the process object document described in the individual instruction information (S26).

Each of the service processors 24 interprets the service process request contents described in the individual instruction information for the document obtained, executes the service process (S28) and stores again the document for which the service process has been executed to the original storing destination (S30).

Moreover, each of the service processors 24 decides whether storing is set in the individual instruction information or not (S32). When the storing is not set, the process of the service processors 24 is terminated here. When the storing is set, the source data of the process object document and the service ID for identifying the service requested from the cooperation process server 22 are stored under the correspondence between them (S34). Namely, when a fault is generated, the source data is read from the service ID and the service process in the process contents of the instruction form or in the individual instruction information can be executed again. When the encryption is set in this timing, since the source data is also encrypted, ordinary users except for the particular users cannot make access to such source data and thereby security can be improved.

Moreover, each of the service processors 24 decides whether the timing is the predetermined one or not (for example, predetermined time or instruction from users or the like) (S36). When the predetermined timing is detected, the source data which has been stored under the correspondence to the service ID is transferred to the cooperation process server 22 (S38). Here, the decision in the step S36 can also be made, for example, when the data has exceeded the threshold value of the predetermined amount of data, instead of the predetermined timing in order to transfer the source data stored corresponding to the service ID to the cooperation process server 22.

As described above, the cooperation process server 22 can manage simultaneously the source data corresponding to the service ID by transferring the source data stored to the cooperation process server 22 in the predetermined timing and thereby the service process which has generated a fault can be recovered.

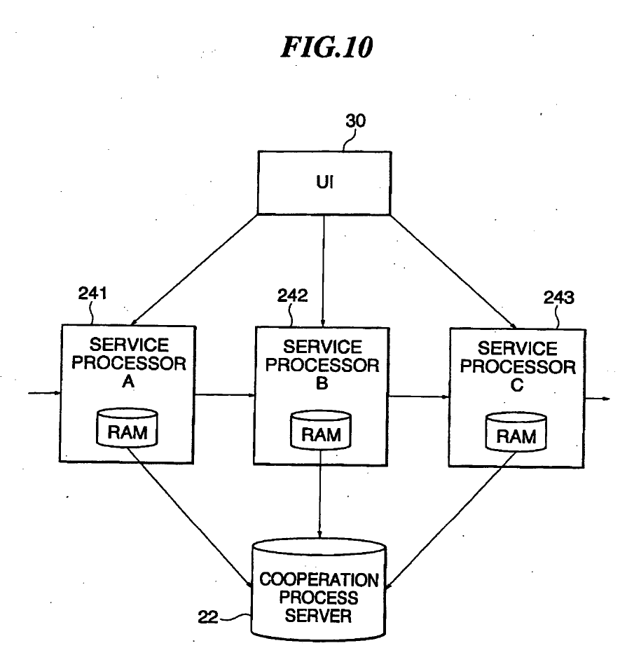

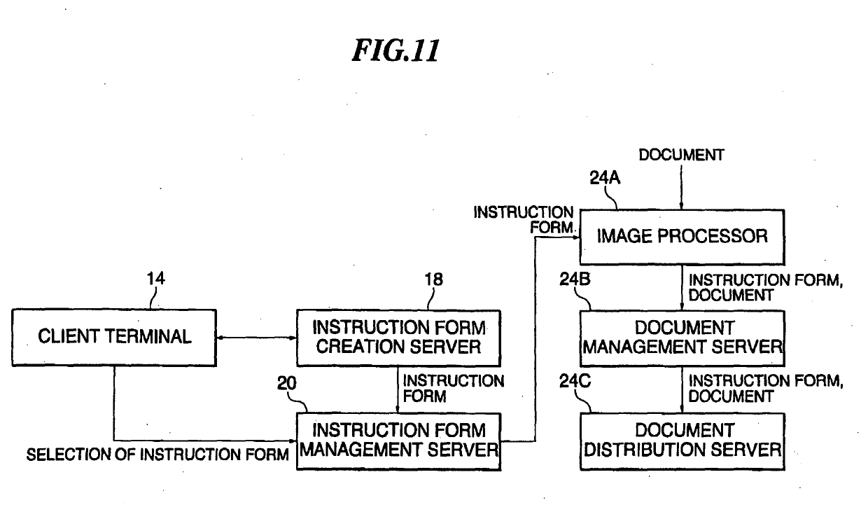

For example, it is considered here that the service is provided sequentially to the service processor A241, service processor B242 and service processor C243 as illustrated in FIG. 10. Each of the service processors 24 stores the source data to the RAM 24c in correspondence to the service ID (it is also possible here to provide another exclusive memory or the like in place of the RAM 24c). Accordingly, when a fault occurs, the source data of service can be searched based on the service ID from a UI 30 of the client terminal 14 or the like. Moreover, the service process can be executed again from the service of the service processors 24 which cannot be executed because of the occurrence of the fault based on the contents of instruction form corresponding to the service ID.

Moreover, since the source data corresponding to the service ID stored in each of the service processors 24 at the predetermined timing is stored in the cooperation process server 22, if a fault is generated, the service process can also be executed again from the service of the service processors 24 which cannot be executed because of occurrence of fault by also making access to the cooperation process server 22 from the UI 30. In this embodiment, the source data corresponding to the service ID is stored simultaneously to the cooperation process server 22, but it is also possible to provide the exclusive simultaneous management server. In addition, the source data is stored corresponding to the service ID in this embodiment. However, when each of the service processors 24 has a unique process identifier (job ID) and the service ID is different from the job ID, the service process can also be recovered if a fault is generated by storing further the corresponding service ID and job ID. Moreover, these service ID and job ID, etc. can be set depending on the users' instruction.

The UI 30 searches the source data in each service or in the cooperation process server 22, for example, by inputting the service ID and displays the corresponding source data group. In this case, the graphical display may also be implemented.

Here, the cooperation process server 22 can manage the source data corresponding to the service ID as described below.

The cooperation process server 22 stores the source data in relation to the service ID leaving only the differential information. Namely, not all the source data of each of the service processors 24 is stored. For example, the service processors 24 which perform electronic service processes added subsequently are not required to store all the source data. When the source data of the processes in the preceding stages is stored, the data added subsequently is stored as the differential information. Accordingly, the amount of data to be stored can be reduced. In addition, as the differential information, it is also possible to place the information under the management in such manners that an image is differentiated and extracted in unit of pixel, an image to be added is placed under the management as the vector information, and only the process contents processed in each of the service processors 24 is placed under the management.

In the embodiment described above, the plural service processors 24 are controlled with the cooperation process server 22 and the present invention is adapted to the aspect to execute the job flow based on the instruction form. However, the present invention is not restricted thereto. For example, as illustrated in FIG. 11, the present invention can also be adapted to the aspect where the cooperation processes of plural services are executed without control of the plural service processors 24 with the cooperation process server 22. In FIG. 11, the same elements in this embodiment are designated with the same reference numerals and details description of these elements are eliminated.

In details, users can invoke the cooperated processes by selecting the desired instruction form from plural instruction forms stored in the instruction form management server 20. More practical operations will be described below.

The client terminal 14 selects, depending on the manipulation of users, the instruction form indicating the desired service cooperation process from the service cooperation process selection image and instructs invocation of the instruction form. The instruction form management server 20 transmits the instruction form instructed by the client terminal 14 to the image processor 24A.

The image processor 24A obtains a document of the process object based on the storing destination location information of the process object document described in the instruction form transmitted. The image processor 24A performs the image processes such as noise elimination and OCR processes, etc. by interpreting the service process request contents to the document image obtained and also performs the process bound to the extracted text documents. The image processor 24A also. deletes, after the predetermined image process, the service process request described in the instruction form. Thereafter, the image processor 24A transmits, to the document management server 24B to provide the next service process, the document in which the image document obtained by the image process is bound to the text document and the instruction form including the status information of the process (completion), output parameter, and a result of the process such as the document storing destination information after the process.

Moreover, the image processor 24A is also capable of transmitting, after the predetermined image process, the document and instruction form to the document management server 24B after correcting or deleting the part regarding its own service request described in the instruction form. In addition, the image processor 24A may also be configured to transmit the instruction form to the next service processor 24 after completion of the predetermined image process.

The document management server 24B temporarily stores the document transmitted from the image processor 24A to the storing destination described in the instruction form. The document management server 24B deletes the service process request described in the instruction form and then transmits the document and instruction form to the document distribution server 24C to perform the next service process.

The document distribution server 24C transmits, based on the instruction form, only the text document among the documents where the text document and image document are bound to the mail address designated as the distribution destination and also transmits only the image document to the designated facsimile number address. Upon deciding that the next process is not described in the instruction form, the document distribution server 24C notifies that all processes have been completed to the client terminal 14 and completes the cooperated processes.

Here, it is also possible as described above in the document processing system that each of the service processors 24 stores the source data in relation to the service ID and a simultaneous management server (cooperation process server 22 in the embodiment described above) is provided to store the source data in relation to the service ID.

Moreover, in the above embodiment, setting of encryption and setting of storing are included in the instruction form, but the present invention is not restricted thereto. For example, it is also possible to perform the setting of encryption and setting of storing for each of service processors 24.

As described above, according to the present invention, if a fault is generated, the source data can be searched from the identifying information by storing, based on the preset setting information, the source data before the predetermined process in relation to the identifying information to identify the relevant service cooperation. Therefore, the predetermined process performed in the relevant service processor can be executed again from the source data searched and thereby the present invention can also provide the effect that an adequate measure can be taken easily for occurrences of faults.

The entire disclosure of Japanese Patent Application No. 2003-81199 filed on Mar. 24, 2003 including specification, claims, drawings and abstract is incorporated herein by reference in its entirety.

What is claimed is:

1. A service processor which processes, in cooperation, various services to execute processes on document data on a network, comprising:
a storage part which stores source data before a process in the own device in relation to identifying information to identify cooperation of services; and
a control part which controls the storage based on setting information which presets whether the source data should be stored or not.

2. The service processor according to claim 1, wherein the storage part stores own device identifying information with further relationship when the identifying information is different from the own device identifying information to identify the service in the own device.

3. The service processor according to claim 1, wherein the storage part stores the source data, which is encrypted depending on a predetermined setting of encryption.

4. A service processing system which processes, in cooperation, various services to perform processes of document data on a network, comprising:
the service processor according to claim 1; and
a storage device which stores the source data stored in the storage part.

5. The service processing system according to claim 4, wherein the storage device obtains and stores the source data in relation to the identifying information stored in the storage part of the service processor at a predetermined threshold value or a predetermined timing.

6. The service processing system according to claim 4, wherein the storage device stores differential information before and after the processes as the source data among service processors.

7. A source data storing method for a service processing system, comprising the steps of:
processing services to perform, in cooperation, processes on document data according to a process content among plural service processors connected to a network; and
storing source data before the process in the service processor in a predetermined storage area in relation to identifying information to identify cooperation of the service based on setting information which is preset to decide whether the source data included in the process content should be stored or not.

8. The source data storing method according to claim 7, wherein own device identifying information is stored in the storage area with further relationship when the identifying information is different from the own device identifying information to identify the service in the service processor.

9. The source data storing method according to claim 7, wherein the source data is encrypted depending on a setting of encryption included in the process contents and is then stored in the storage area.

10. The source data storing method according to claim 7, wherein the storage area is the service processor.

11. The source data storing method according to claim 7, wherein the storage area is the storage device connected to the network.

12. The source data storing method according to claim 7, wherein the source data to be stored stores differential information before and after the processes as the source data among the service processors.

13. A service processor which processes, in cooperation, various services to execute processes on document data on a network, comprising:
a storage part which stores source data before a process in the own device in relation to identifying information to identify cooperation of services based on setting information which presets whether the source data should be stored or not.

14. A service processor for processing services to a document data at several service domains on a network cooperatively, comprising:
a storage provided to a service domain, the storage storing a source data to be processed at the service domain with a data for defining the services; and
a controller that controls whether the storage should store the source data or not in accordance with a preset data.

15. The service processor according to claim 1, wherein the storage stores the source data with a self-identifying data for identifying a service to be processed at the service domain.

16. The service processor according to claim 1, wherein the preset data including an encrypting setting.

17. The service processor according to claim 1, wherein further comprising a main storage that stores the source data stored in the storage.
